(19) United States
(12) Patent Application Publication
(10) Pub. No.: US 2003/0066073 A1
(43) Pub. Date: Apr. 3, 2003

(54) Methods and systems of interactive advertising

(76) Inventor: Richard G. Rebh, Arlington, VA (US)

Correspondence Address: Woodcock Washburn Kurtz, Mackiewicz & Norris LLP, One Liberty Place -46th Floor, Philadelphia, PA, 19103, US

(21) Appl. No.: 09/965,963

(22) Filed: Sep. 28, 2001

(51) Int. Cl. H04N 7/16; H04H 9/00

(52) U.S. Cl. 725/12; 725/10

(57) ABSTRACT

An advertising system includes a sensor, a display, memory having instructions for illuminating the display in a first pattern and a controller for executing the instructions and illuminating the display when the sensor senses the presence of a human. The sensor may include at least one motion sensor that senses the presence of motion such as human motion. Thus, as a person approaches the system, the persons's motion will be detected and the controller will illuminate the display to according to the first pattern. The system therefore is responsive to the consumer and performs certain functions upon detecting the presence of a human which will attract the a person's attention and carry the message to the consumer. The memory may further contain instructions for illuminating the display in a second pattern when the sensor does not detect the presence of a human. The controller executes this second pattern of instructions and illuminates the display according to this second pattern when the sensor does not detect motion. The controller can also read memory instructions for creating sounds and transmit those sounds with a speaker in response to detected motion, an interface or passed motion. The inventions set forth herein also include methods of conveying information which include illuminating an electroluminescent display and creating a sound when the presence of a person is noted in an area proximal to the display or the speaker.

### FIELD OF THE INVENTION

This invention relates to methods and systems of advertising that can interface with a consumer.

### BACKGROUND OF THE INVENTION

Advertising has traditionally used signs or visual displays to convey product information to a consumer. Although visual displays are effective, there is a need for more effective advertising systems and methods of advertising that will attract consumers, hold their attention and convince them to purchase the advertised product.

Although advertising predominates the world today, one particular field of advertising is the advertising of products within stores, including for example grocery stores or super markets. Traditionally, products are advertised in stores through the use of signs or visual displays. Although signs are effective advertising tools, there is a particular need for new methods and systems of in-store advertising that will convince consumers to purchase various products.

One type of advertising that is particularly effective is so-called floor decals, which are essentially signs that rest on or are adhered to the floor. Advertisers deem floor decals beneficial because floor decals can be located on the floor of a grocery store proximal to the area in which a product is shelved. These floor decals also increase the advertising space that can be utilized in stores and public places. Although the systems and methods of this invention can be used with floor decals, they are not limited in use.

Although floor decals have been met with widespread acceptance, there is a need for systems and methods of conveying information which interface with humans. For example, there is a need for systems and methods of conveying information with floor decals which change their displayed message when the presence of a person is detected. The inventions described herein include, but are not limited to, methods and systems for conveying information which interface with humans. The inventions described herein also include floor displays which have a changing message based upon the how close a human is to the display and whether a human has interfaced with the display.

Moreover, this invention is related to new and interactive systems of advertising that interface with a consumer so that the consumer is attracted to the advertisement, learns about the product and is persuaded to purchase a product.

### SUMMARY OF THE INVENTION

A method and a system of conveying information of this invention generally includes a display, a sensor, a controller, and a memory. The display can be any of a variety of illumination devices for example a plurality of electroluminescent lamps. Electrically connected to the lamps is the controller. Stored on the memory are executable instructions for illuminating the electroluminescent lamps. The sensor can be any of a variety of sensors and in a preferred embodiment is a motion sensor. Moreover, the sensor can include a plurality of sensors.

Upon the motion sensor detecting the motion, the sensor sends an electrical signal to the controller indicating that motion has been detected. After receiving the sensor signal, the controller communicates with the memory to execute a first set of instructions and illuminates the display according to these instructions. Thus, the system of this invention illuminates upon detecting the presence of motion, which is preferably but need not be human motion. This is beneficial because the change in the display is likely to attract human attention. This increases the likelihood that the displayed message will be conveyed to the target audience.

The memory may also have a set of instructions for illuminating the display when no motion is sensed. The controller executes these instructions to illuminate the display when the sensor does not send a motion signal to the controller. Thus, according to this aspect of the invention, a first message can be displayed when no motion is detected and a second message can be displayed when motion is detected.

Also included within the system may be an interface device, such as a touch pad with buttons, which is in electrical communication with the controller. A consumer can activate this interface device to send an interface signal to the controller. Upon receiving an interface signal, the controller reads another set of memory instructions and executes these instructions. In accordance with these instructions, the controller illuminates the display in the specified pattern.

According to another aspect of this invention, the controller returns the display to the no motion sensed display after sensing motion or receiving an input signal. This can also be done by having a timer or clock built into the controller. The controller can set the clock when the interface signal is received, when the motion sensed signal is received, upon executing the instructions corresponding to the interface signal, or in response to a motion sensed signal. After a predetermined period of time the clock or timer signals the processor to return the display to the no motion sensed display.

Stored within the memory may be several sets of instructions. the controller can be programmed to execute one set of instructions when no motion is sensed, one set when motion is sensed, and one set when an interface signal is present. Preferably, the memory can store up to four sets of instructions for each mode, motion sensed, no motion sensed and interface. The controller and the memory can also be programmed to change the set of instructions which is executed. For instance, in the no motion sensed state, the controller can be programmed to execute one of the four sets of stored instructions in a cyclic fashion. Alternatively, the controller can be programmed to change the no motion sensed display after a period of time or after a certain number of uses. The controller can likewise be programmed to change the motion sensed and interface displays over time or after a certain number of uses. This is advantageous because the advertising material changes which increases the likelihood of attracting consumer attention.

Thus, a system or method of this invention may have three modes of operation, which may be termed an attract, an audience and a response mode. When no motion or interface is detected, the system operates in the attract mode. In the attract mode the controller executes memory instructions to illuminate the display in a first pattern. The audience mode is used when motion is sensed. In the audience mode, the controller executes memory instructions for illuminating the display in a second pattern. When an interface signal is present, the response mode is used. While in the response mode, the controller executes memory instructions and thereby illuminates the display according to a third pattern. Further, after detecting that motion has passed the display, the controller can execute the instructions for displaying the first pattern and return the system to the attract mode. It will be appreciated that the systems and methods of these inventions need not have all of these aspects and may have some or all of them.

The system of this invention may further include a speaker and the memory may further include executable instructions for creating sounds in the attract, audience and response modes. For instance, when no motion is sensed, the controller can execute a corresponding set of memory instructions to create a first sound. Likewise, when motion is sensed, the controller can execute a corresponding set of memory instructions to create a second sound, and when an interface signal is present the controller can execute a corresponding set of instructions and create a third sound.

The controller can be programmed to execute the memory instructions with respect to sound in response to sensors used for changing the display or in response to different sensors. Thus, the system and method can change sounds when the display changes or at different times then the display. For example, by using different motion sensors the display can change from the attract mode to the audience mode before or after the sound changes from the attract mode to the audience mode.

It will be appreciated that the systems and methods of this invention need not use all three sound modes. For instance, the system and method may have no sound or sound only in the audience or response mode. It will further be appreciated that all of the display modes need not be used with all of the sound modes and combinations of them may be used.

The information conveying systems of this invention can have a variety of applications, one of which is floor advertising systems or floor decals. In such applications, the system can be placed on the floor of a store. The store could be for example a grocery store and the application could be a product shelved in the grocery store. A floor decal having a display of a certain product could be disposed within the grocery store proximal to where the item is shelved. Thus, as a person approaches the shelving area of the product, the advertising system can be activated to illuminate the display in a different mode. Moreover, the consumer can interface with the system. According to another aspect of the methods and systems of this invention, an input device can be used to input various settings. For example, it may be desirable to display textual information such the price of a product. Through this input device the price could be changed. The input device could communicate with the controller and the memory to store inputted information in the memory. The controller can be programmed to read this stored information and communicate with a display to convey this information. The display could be a lighted display using incandescent, flourescent or electroluminescent lamps.

According to another aspect of this invention, the system and method can generate an aroma in the various mode of operations. For example, a different fragrance can be generated while in each mode of operation, the attract mode, the audience mode and the response mode. In order to accomplish this, the system may include a plurality of aroma generators which are connected to the controller. The controller can activate one of these aroma generators upon receiving a motion sensed signal, an interface signal or a no motion sensed signal. It will be appreciated that this aroma aspect of the invention can be practiced with or without the display and sound generating aspects described above. It will be further appreciated that some or all of the aroma aspects of the invention may be employed in combination with various aspects of the display and sound aspects. For example, there may be an aroma generated only in the audience or interface mode.

Other features of the invention are set forth below.

### BRIEF DESCRIPTION OF THE FIGURES

FIG. 1 is a schematic diagram of a preferred embodiment of this invention;

FIG. 2 is a preferred embodiment of an information conveying system of this invention;

FIG. 3 is a flow chart of a preferred embodiment of a method of this invention;

FIG. 4 is a flow chart of a second preferred embodiment of a method of this invention;

FIG. 5 is a flow chart of a third preferred embodiment of a method of this invention; and

FIG. 6 is a flow chart of a fourth preferred embodiment of a method of this invention.

### DETAILED DESCRIPTION OF EMBODIMENTS

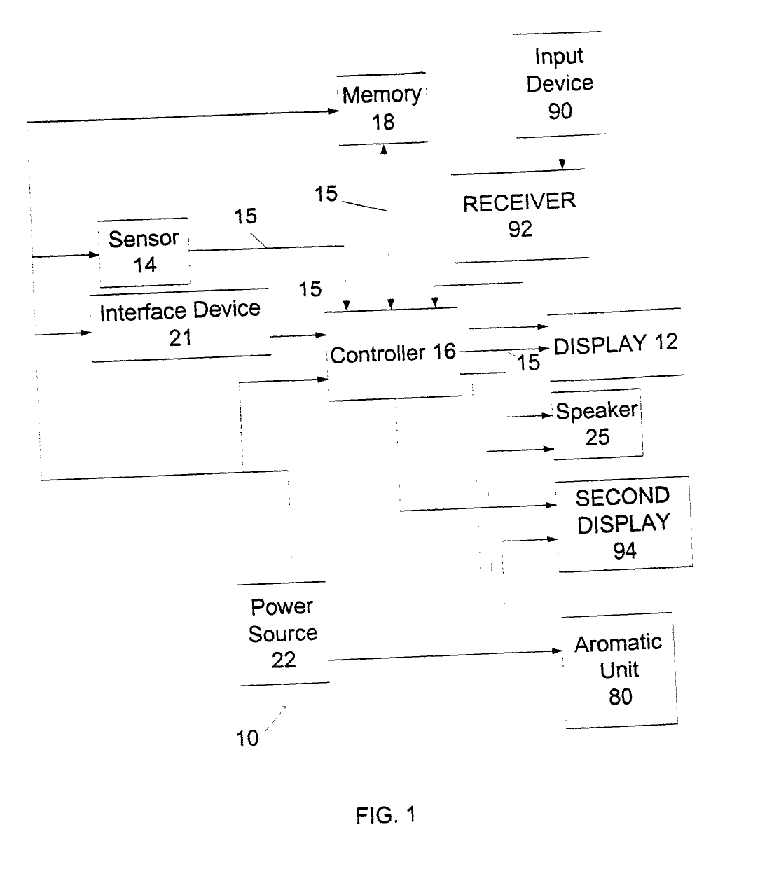

FIG. 1 depicts schematically a preferred embodiment of a system 10 according to this invention. This embodiment includes a floor display 12, a sensor 14, a controller 16 and a memory 18. By way of overview, the system 10 illuminates the display 12 in various patterns depending upon whether motion is sensed. If there is no motion sensed, the controller 16 illuminates the display according to a first pattern. Alternatively, if motion is sensed, the controller 16 illuminates the floor display according to a second pattern. While illuminated in the first pattern, the system 10 will preferably attract attention from consumers at a distance. When illuminated in the second pattern, the consumer is preferably approaching the system floor display 12 and therefore this second pattern will preferably attract consumer attention and convey additional information.

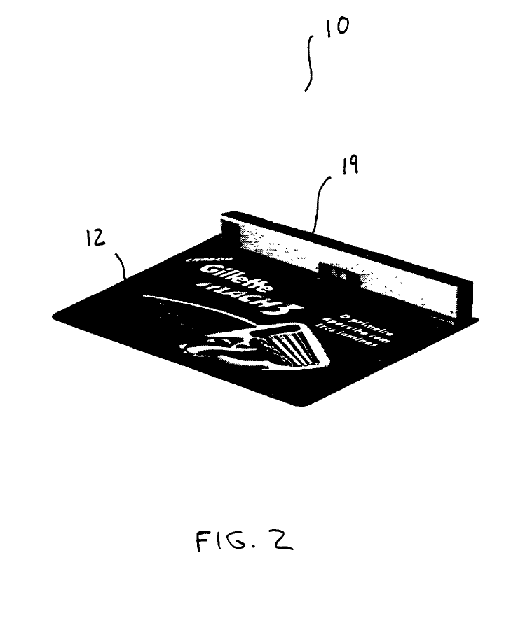

FIG. 2 is a preferred embodiment of this invention and shows the floor display 12 and a housing 19. The housing 19 stores the sensor 14, the controller 16 and the memory 18. The display 12 is in this example an advertisement for Gillette™ products. The first pattern illuminated could be for example, the term Gillette™. The second pattern could include more specific product information and for example with reference to FIG. 2, the stripe and the razor could be illuminated. As described below, the display is in the preferred embodiment an electroluminescent display that can be illuminated to create an animated effect. The illumination of the system as well as the changing message of the display 12 as a consumer is determined to be proximal to the system is advantageous in attracting consumer attention and holding that attention so that product information can be conveyed.

Although the system 10 has many applications, one application is in floor decals as shown for example in FIG. 2. Thus, the system can be placed for example on the floor of a grocery store proximal to the location at which the product being advertised in the display is shelved. With this application, consumer attention can be attracted as the consumer walks down a grocery store aisle and approaches the shelved product location. Further, by changing the display, additional product information can be conveyed as the consumer approaches the shelved location.

Although the system 10 is discussed herein as advertising products, it will be appreciated that the system 10 could be used in a variety of ways. For example, the system 10 could be used to advertise services, convey political messages or to convey any type of information. The term products is used herein to refer to the conveying of information and is not meant to limit the system to the advertising of products as to the exclusivity of conveying other information.

The system 10 components, including for example the sensor 14, the controller 16, the memory 18 and the display 12, are all powered by a power source 22, which is shown schematically in FIG. 1. The power source 22 is preferably a battery or plurality of batteries. In a preferred embodiment the power source includes a plurality of D-cell batteries and preferably sixteen such batteries. The system components are preferably battery powered so that the system is a stand alone system and does not require cords and the like. Battery power eliminates the need for cords which can be aesthetically distasteful and a tripping hazard. Battery power is also beneficial because the requirement for cords can limit the number of locations that a system can be located. Because a DC battery is used, the system contains a DC-AC converter, such as an inverter, (not shown) to convert the power signal to AC for use in the various system components. Although it is preferred that a DC power source be used, the power source can be AC unless specified otherwise in the claims. As shown schematically in FIG. 2, the various system components can be connected by data buses which are denoted generically by reference numeral 15.

### The Display

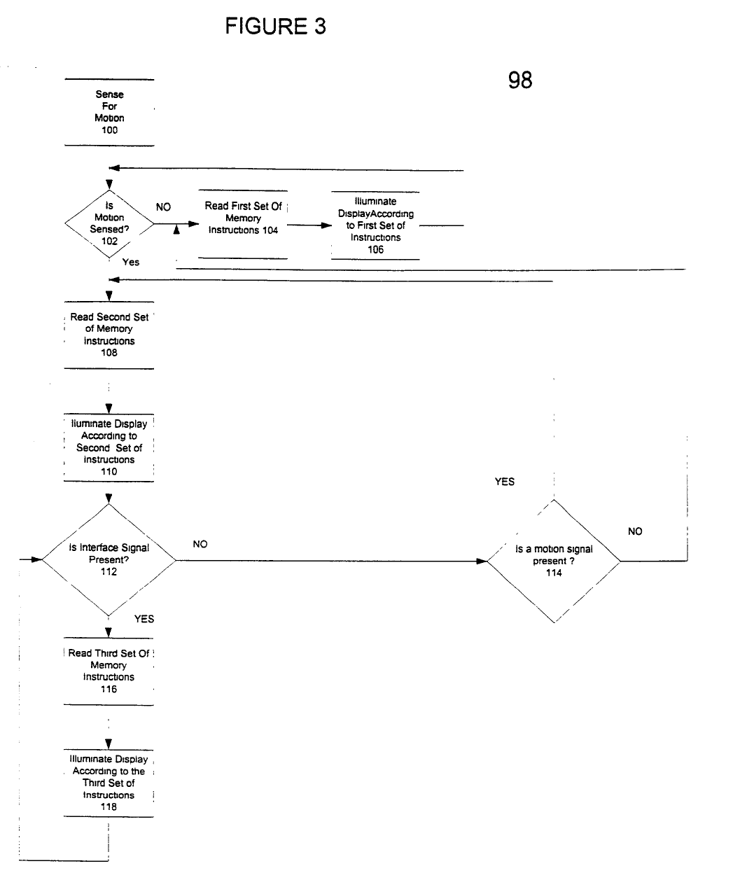

The display 12 can be a variety of displays. Preferably, the display is a “floor decal” or floor display. The floor decal can be disposed on the floor of a grocery store, including for example on the floor of an aisle proximal to the location at which the advertised product is displayed. There are various floor decals, which are well known in the art, and it will be appreciated that although FIG. 3 depicts one embodiment of a floor decal, this invention can be used with any floor decal. Moreover, it will further be appreciated that there are various inventions set forth herein, some of which need not include a floor display. Some of the inventions set forth herein require a display and others do not need a display, but may include a display.

In the embodiment shown in FIG. 3, the display 12 is an electroluminescent lamp which includes a plurality of electroluminescent lights. Although in the embodiment shown in FIG. 2, the lamp has an advertisement for Gillette™ Mach 3 razors, it will be appreciated that the lamp could be adapted to convey any message that is suitable for customer needs. As shown, the advertisement can include pictures, such as a picture of a consumer product (a razor) and textual matter.

### The Sensor

The sensor 14 is preferably a motion sensor and may include a plurality of motion sensors. The term sensor is used herein to refer to at least one sensor and can include any number of sensors. The motion sensors can be infrared. The sensor 14 is preferably electrically connected to the controller 16 by a bus or any suitable circuitry.

The sensors are preferably disposed in the system 10 to detect motion coming toward the system or proximal to the system. The specific point of reference could be the display, as shown in FIG. 2. Alternatively, the sensor could be located remotely. The motion sensors are also preferably adjustable so that the motion can be sensed at a maximum distance from the system 10. In a preferred embodiment, the sensor senses motion at about 15 feet from the sensor. These distances are mere preferences, and it will be appreciated that any desired distances can be used. If the sensor 14 senses motion approaching or proximal to the display 12, the sensor 14 sends a signal to the controller indicating the same. Alternatively, if not motion is sensed, the sensor sends a signal to the controller that is indicative of no motion being be sensed. As described further below, the controller is programmed to determine if the sensor senses motion and to operate in response to a signal from the sensor to read the memory, execute the memory instructions and illuminate the display 12 based upon this signal.

In a preferred embodiment, the sensor 14 is a photo-conductive cell. Preferably, the photo-conductive cell is cadmium sulfoselenide. The photo conductive cell is connected to the controller 16 and has two leads. A characteristic of the photo conductive cell is that its electrical resistance is inversely proportional to incident optical energy. Preferably, in the dark the cell has a resistance that is greater than about 1 mega ohm, and in bright light it has a resistance of about 1 kilo ohm or less. Thus, the cell's resistance changes with the incident optical energy. In operation a voltage signal is placed across the cell, and the controller 16 monitors the magnitude of the voltage. When the incident light is constant or within a given range, this indicates no motion. When a consumer approaches the display and enters the sensor path, the incident light energy will decrease, this causes the cell's electrical resistance to increase. The increase in resistance changes the voltage across the cell. The controller detects the voltage change, and if it is within a given threshold level, this indicates sensed motion. Thus, the controller 16 executes the stored memory instructions corresponding to the sensed motion.

After a consumer has passed the cell, the incident light energy will increase. This decreases the cell's resistance, and changes the voltage across the cell to the value that is indicative of no motion sensed. The processor detects this change, determines that the voltage is indicative of no motion by comparing it to a stored value or range, and then executes the memory instructions to return the display to the no motion sensed display.

### The Memory & The Controller

As shown schematically in FIG. 2, the system 10 preferably includes computer memory 18, which may be read only memory or any other suitable memory. The memory 18 contains an executable computer code with instructions for illuminating the display 12. For instance, a sequence for lighting the various portions of the display can be stored, so that the display can be lit in sequence to generally enhance the advertisement and attract consumer attention. For example, with reference to FIG. 1, the multi-colored stripe to the left of the razor can be lit from left to right to create a visual affect. Following this the razor can be illuminated.

Connected to the sensor 14 and the memory 18 is preferably a controller 16 or processor for controlling the illumination of the lamp in response to the sensor and as set forth in the memory 18. In a preferred embodiment, the controller is a “Smart Chip” controller available from ADD-Vision, Inc. of Pacifica, Calif. The methods of this invention, as well as the operation of the memory 18 and the controller 16 are best understood with reference to the flow chart of FIG. 3 and are described in detail below. The controller 16 can be programmed to execute the instructions set forth in the memory 18 and communicate data/information from the instructions to the display 12 through data bus 15 and thereby illuminate the display 12.

The controller 16 can also be connected to the sensor 12 by data bus 15, so that the sensor 14 can communicate with the controller 16 to provide the controller 16 with signals that are indicative of motion being detected and motion not being detected. The controller 16 can be programmed to determine which signals are being sent by the sensor 14 and to communicate with the memory 18 and control the illumination of the display 12 in response to the signals being sent by the sensor 14.

Preferably, the memory 18 contains a first set of instructions for operating the system 10 in an attract mode. In this attract mode, the controller 16 reads the memory instructions and instructs certain portions of the display to illuminate according to the first set of memory 18 instructions. This first set of instructions can include for example instructions for illuminating the display 12 in a manner that will attract a consumer, such as repetitively flashing the name or brand of a product. With reference to FIG. 1, this could be the illumination of the name Gillette™ or Mach 3 or both. These examples are exemplary only and numerous other lighting configurations which will attract a consumer can be used. Preferably, the controller 16 will execute these instructions and operate the system 10 in an attract mode until the sensor detects motion. It will be appreciated that the first set of memory 18 instructions could be any suitable instructions for illuminating the display in any desired pattern.

The memory 18 also preferably contains a second set of instructions for operating the controller 16 in an audience mode. Once the sensor senses motion, a signal is sent to the controller 16, a preferred embodiment of which is described above. Upon receiving a motion signal from the sensor 14, the controller 16 reads the memory 18 to determine the instructions for operating in an audience mode, which is preferably a second lighting sequence. This second lighting sequence is preferably different from the first lighting sequence and even more preferably one that creates an animated effect. In this mode, the controller 16 communicates with the memory 18 to light the electroluminescent lamps in the sequence provided.

After executing the lighting sequence for the second mode, the controller 16 determines if a motion sensed signal is detected. If there is a motion sensed signal, the controller 16 re-executes the audience mode and illuminates the lamps again in accordance with the audience mode instructions. Alternatively, if there is not a motion sensed signal, the controller executes the first set of memory instructions and illuminates the display in the attract mode. This process continues until the motion sensor 14 senses another customer, at which point the system repeats the steps described above.

In another preferred embodiment, the controller 16 may include a clock or timer that is set when the motion sensed display is illuminated and that returns the system to the no motion sensed display after a predetermined period of time.

In other preferred embodiments, the memory may contain multiple sets of instructions for illuminating the display in the attract and audience modes. Each set of instructions can illuminate the display in a different manner, and the controller executes one set in the audience mode and one set in the attract mode. The controller can be programmed to change the set of instructions it executes in either the attract or audience mode. For example, the controller may alternate or cycle through the stored instructions for each mode. Alternatively, the controller can be programmed to select a different set of instructions in each mode after a predetermined period of time. This feature is beneficial because it permits the changing of the display, which is more likely to attract consumers.

### Interface and Response Mode

The system may further include a third mode of operation called a response mode, and the memory 18 can contain computer code and instructions for operating the system in a response mode. The memory 18 may contain instructions for illuminating other aspects of the display in the response mode. The instructions may include sequential lists of display lamps, such that a sets of lamps are illuminated in sequence in order to create an animated display.

An input device 21, such as a touch pad or floor pedal, as shown schematically in FIG. 2, can be electrically connected to the controller 16. A consumer can activate the touch pad or switch 21 to send an interface signal to the controller 16 that a consumer has touched the switch. The controller 16 can be programmed with instructions and code for recognizing the presence of the interface signal and then reading the memory 18 response mode instructions and executing them. Upon executing the response mode instructions, the controller 16 illuminates the display in accordance with the instructions. After executing the response mode instructions, the controller 16 returns to the audience mode unless consumer is sensed in which instance the controller 16 and the system return to the attract mode.

The memory and the controller can also illuminate the display 12 in different ways in the response mode by having multiple sets of stored instructions for illuminating the display in the response mode. The controller can execute a different set of instructions each time by cycling through the instructions. Alternatively, a clock can be used to change the executed response mode instructions with time. This is similar to the audience and attract mode instructions described above.

### The Methods and System Operation

FIG. 3 depicts a flow chart explaining a preferred method 98 and the operation of the system 10 of this invention. At step 100 the sensor 14 determines if motion is present and sends a signal to the controller 16 via bus 15 that is indicative of either motion being detected or not being detected. This sensed motion can be motion from any desired reference point. In this example, the sensed motion is that approaching or proximal to the display and that which has passed the display.

Following this, at step 102 the controller 16 receives the signal from the sensor and determines which signal, a motion sensed or no motion sensed signal, is present. If the controller 16 determines that no motion is present, the controller 16 communicates with the memory 18 at step 104 to read and execute the first set of memory instructions. Upon executing the first set of memory instructions, the controller 16 illuminates the display according to the first set of instructions at step 106. Following this, controller 16 again executes step 102 and determines whether a motion signal is being received from the sensor 14. If a no motion signal is present, the controller 16 continues to execute the first set of instructions and illuminates the display accordingly at steps 104, 106 This is the attract mode of operation, and the controller 16 remains in the attract mode until a motion sensed signal is determined to be present at step 102.

When the controller 16 determines that a motion sensed signal is present at step 102, the controller 16 communicates with the memory 18 to read the second set of instructions for illuminating the display 12 at step 108. The controller 16 then instructs the display 12 at step 110 to illuminate in accordance with the pattern set forth in the second set of instructions. This is the audience mode of operation.

After executing the second set of instructions, the controller 16 determines at step 112 if an interface signal has been received from the interface device 21. The interface signal is generated by the interface device 21 in response to activation of the input device 21 by a human. If no interface signal is present, the controller 16 determines at step 114 if the motion detected signal is present. If the controller 16 determines that a motion present signal is not present at step 114, then the controller 16 executes the first set of memory instructions to illuminate 106 the display in the attract mode at steps 104, 106. Conversely, if there is a motion present signal, than the controller 16 remains in the audience mode, executes the second set of instructions 108 and illuminates 110 the display 12 according to the second set of instructions at steps 108, 110.

If the controller 16 determines that an interface signal is present at step 112, then the controller 16 reads the third set of memory instructions at step 116 and illuminates the display 12 at step 118 according to the third set of memory instructions. This is known as the response mode. The controller may be programmed to operate the third set of instructions for a set amount of time. Following this, the controller 16 again determines at step 112 if an interface signal is present, and if so repeats the third set of instructions 116, 118. If no interface signal is present, at step 112 the controller 16 determines at step 114 if a motion detected signal is present. If there is not a motion detected signal the controller 16 returns to the attract mode, executes the first set of instructions for illuminating the display in the first pattern at steps 104, 106. After which, the controller 16 determines at step 102 whether there is a motion signal. Alternatively, if there is a motion signal 114, the controller 16 returns to the audience mode, executes at step 108 the second set of instructions and illuminates at step 110 the display 12 according to the second set of instructions.

In summary, the preferred method of this invention conveys information in a display when no motion is sensed, and then conveys a different information when motion is sensed. Further, the method can convey additional information when an interface is detected.

This preferred method of conveying information can be practiced with some or all aspects of the preferred method. For example and not by way of limitation, the method can have just an audience mode, an audience mode and a response mode or an attract and an audience mode. It will thus be appreciated that the methods of this invention can be practiced with some or all of the aspects of the preferred method described above.

This method may execute a different set of stored memory instructions in the attract, audience and response modes each time the cycle is repeated or after a predetermined period of time. This permits the changing of the display in the audience mode, the attract and response modes. Alternatively, the controller can cycle through the instructions stored for each mode. For example, if there are four sets of stored instructions for the response mode, then the controller can execute a certain set every fourth time it operates in the response mode. The same can be true for the audience and attract modes.

In an alternative embodiment, the system operates in the attract made until a motion present signal is detected. When the motion present signal is detected, the system operates as above and enters the audience mode. A clock or timer is started and after a predetermined period of time, the system returns to the attract mode unless an interface signal is sensed. If an interface signal is sensed, the controller executes the response mode instructions. Again, a clock or time is started and the system returns to the attract mode after a predetermined period of time.

### Sound

The system 10 may further include a sound system that includes a speaker 25, as shown schematically in FIG. 1. The speaker can be positioned proximal to or at a distance from the display 12. The speaker 25 can be any of a variety of speakers that are commercially available.

The memory 18 can further contain a fourth set of instructions for generating a first sound signal from the speaker 25, a fifth set of instructions for generating a second sound signal and a sixth set of instructions for generating a third sound signal. It will further be appreciated that the instructions are described with numerals only for differentiation purposes and not to imply that there need be a certain number of instructions or order to those instructions.

The first sound signal can correspond to an attract mode, the second sound signal to an audience mode and the third sound signal to the interface mode. It will be further appreciated that the system can be practiced with out all three sound modes. For instance, a sound system having an audience mode or an audience mode and an interface mode can be employed with or without the display. In this type of method or system, there would be no visual display per se, but rather a speaker that broadcasts sound. It will be further appreciated that the sounds in each mode are referred to as a first, a second and a third sound, but one or more of the sounds may be the same if desired.

The controller 16 can be programmed to execute the instructions contained on the memory 18 for broadcasting sound from the speaker. The sensor 14 or other separate sensors 14 can be set to determine if motion is approaching the speaker or proximal to the speaker. When motion is approaching the speaker or proximal to the speaker 25, the sensor 14 can generate a signal to the controller 16 indicating that motion is approaching the speaker. Similarly, when motion is not present proximal to the speaker, the sensor 14 can generate a signal to the controller 16 indicating that the motion has passed the speaker 16. This can be done in accordance with the discussion above with respect to the sensor and the controller.

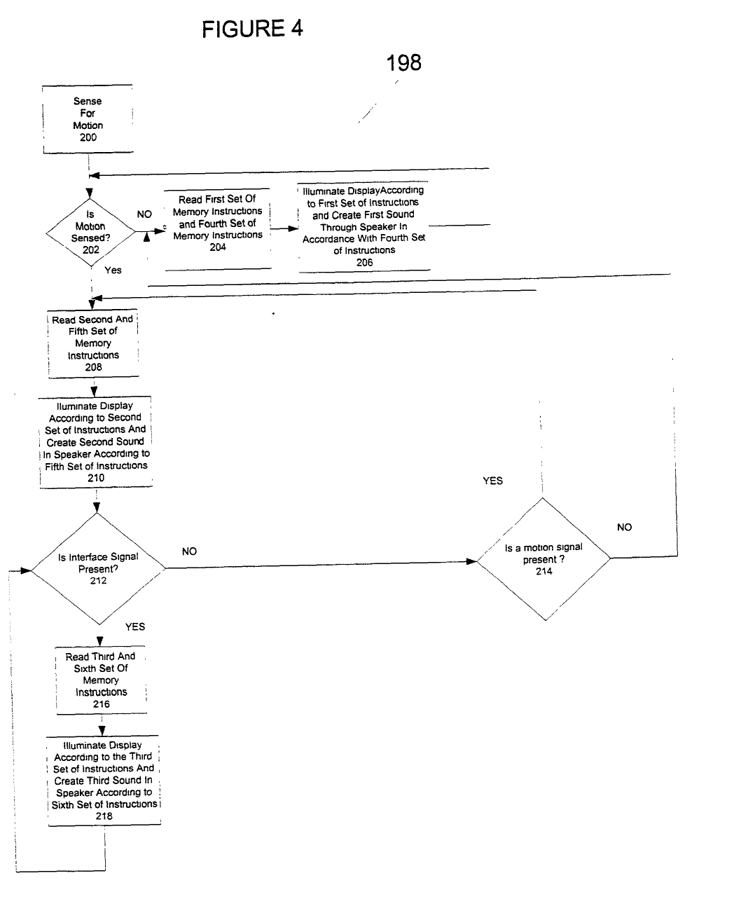

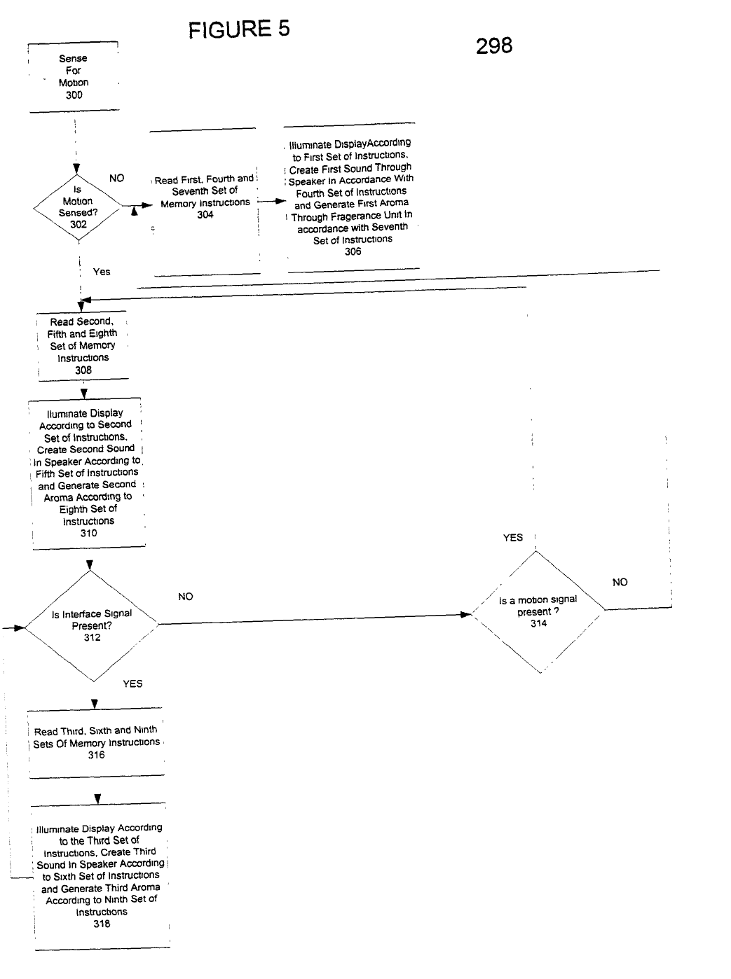

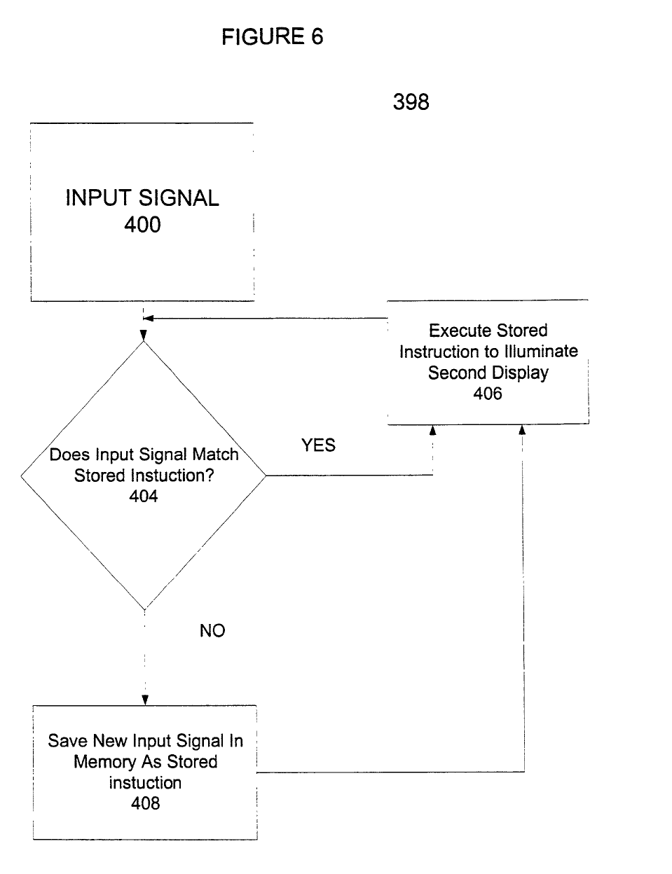

When the system or method uses a display and sound, the method of this invention is similar to that described above except that the controller 16 can execute the instructions for creating sound depending upon whether the system is in the attract mode, the audience mode or the response mode. This is best understood with reference to the flow chart of FIG. 4. A preferred method 98 of operating the system with respect to the display will not be repeated here as the method of operating the display is as described above. This can be understood by comparing FIGS. 5 and 6.

As shown in the flow chart of FIG. 4 the preferred method 198 of operating the system 10 with sound is similar to that described above except that when a motion signal is not present and the system is operating in the audience mode, the controller reads the fifth set of instructions at step 204 and creates the first sound at step 206. Thus, while in the attract mode the first sound and the first display pattern can be transmitted to the target audience. The first sound, as well as the second and the third sounds, can be any of a variety of sounds, including but not limited to words, sentences, phrases and non-word sounds. The first sound could be for example, music or an advertising slogan.

The controller 16 continues in the attract mode repeating the first sound, until the controller 16 determines that a motion signal has been sent from the sensor 14 at step 202 indicating that there is motion approaching the speaker. Once the controller 16 determines that a motion signal is present, the controller 16 reads the memory at step 208 and executes the fifth set of instructions and generates the second sound in the audience mode of operation at step 210. At step 208 the controller 16 can also read the second set of memory instructions for illuminating the display and illuminate the display at step 210 in accordance with the second set of instructions.

After executing the fifth set of instructions, the controller determines if the interface signal is present at step 212. If the interface signal is not present, the controller determines whether a motion signal is present at step 214. If there is a motion signal present, the controller reads the fifth set of instructions again at step 208 and creates the second sound 210. In other words, the controller 16 remains in the audience mode. Conversely, if there is not a motion signal present at step 214, steps 204 and 206 are repeated and the controller 16 returns to the audience mode at steps 208, 210.

If, however, the controller 16 determines that an interface signal is present at step 212, the controller reads the sixth set of memory instructions at step 216 and creates the third sound at step 218. This is the response mode of operation. After executing the third sound at step 218, step 212 is repeated and it is again determined if there is an interface signal. The method continues to operate as described above to execute either the attract, audience or response mode depending upon the sensed signals.

As alluded to above, if the display 12 is used, the method 198 operates the same as described above with respect to the display at steps 100-118 and as set forth in the flow chart of steps 200-218. As also discussed above, the methods of this invention need not include sound in all modes or display in all modes. Thus, for example, the method 200 could be practiced without a first sound and a fourth set of instructions, but the method would otherwise be the same.

As mentioned above, the methods of operating the system can be based on determining if motion is proximal to the display as opposed to the speaker. It will be appreciated that the method would be similar to that described above except that the sensor signals would be based on sensing motion relative to the display. Moreover, the sensor can use any other suitable point as a reference point and the reference point for the sensed motion need not be the display or the speaker.

It will further be appreciated that the memory can have multiple stored instructions for generating different sounds in the attract, audience and response modes. For example, the memory's fifth set of instructions may contain instructions for generating four different sounds. The controller can cycle through the sounds every fourth time it is in the audience mode or cycle through after the audience mode has been selected for a given period of time. Thus, similar to that described above with respect to the display, the system 10 can cycle through or change the sounds generated in each mode of operation.

### Aroma

The system 10 and methods of this invention may further include an aromatic unit 80 as shown schematically in FIG. 1. This aromatic unit 80 can generate at least one and preferably more than one aroma in response to instructions from the controller. The controller 16 can be programmed to control the operation of the aromatic unit 80. The memory 18 can include one or more sets of instructions for instructing the controller 16 with respect to the aromatic unit 80. For example, the memory 18 can contain a seventh set of instructions for creating a first aroma, an eight set of instructions for creating a second aroma and a ninth set of instructions for creating a third aroma. The first, second and third aromas can correspond respectively to the attract mode, the audience and the response mode. Thus, with the system of this invention a different aroma can be created in each mode of operation described above. It will be appreciated that the display systems and methods of illuminating the display described above can be practiced with or without aromas and with one or more aromas. For example, it may desired only to have an aroma in the response mode.

The aromatic unit 10 can include any of a variety of structures. For example, the aromatic unit can include a container which is filled and pressurized with a fragrance. A controller outlet valve seals the container, is open to atmosphere, and when it is opened places the contents of the container in fluid communication with the atmosphere. The control valve may be electrically operated, such as a solenoid valve, and may be coupled electrically to the controller. Upon receiving a signal from the controller indicating that motion has been sensed, or that an interface signal has been received, the controller can open the valve and release, due to pressure, the fragrance. When motion is no longer sensed, after a predetermined period of time, or after the interface signal is no longer receved, the controller shuts the valve, so that the fragrance is no longer emitted.

The system 10 may have one or more aromatic units 10 such that different fragrances can be emitted in the response or audience modes.

FIG. 7 depicts a preferred method 298 according to this invention. The method 300-318 is similar to that described above with respect to the display and sound except that the steps for creating aromas have been added to the attract, audience and response modes. Given the explanations above, the various steps of operation 300-318 can be understood without further explanation. The method simply contains the additional steps in each mode of reading the respective instructions and generating the aroma in each mode.

### Input Device

The systems 10 and methods of this invention may further include an input device 90, which is depicted schematically in FIG. 2. The input device can be electrically connected to the controller 16. The input device 90 can be any of a variety of devices such as a locally disposed keypad, a touch pad or a remote unit such as a wireless control, a network or another controller. The system 10 may further include a receiver 92 for receiving the signal from the input device 90 and transmitting the signal to the controller 16.

With the input device 90, the controller 16 can be prompted to change an output setting. For example, the memory may contain instructions for changing the out of the display 12. For example, the lighting sequence for the first set of instructions could be changed to a different set of instructions. Thus, the system's attract mode display could be changed. This applies as well to any of the other displays, sounds or aromas.

Furthermore, the system 10 can include a second display device 94. This second display device could be for example an incandescent display and may include textual or pictorial information. In one example, the information is price. The displayed price information could be changed by inputting a new price to the controller. The controller 16 can be programmed with code for determining if a new price signal is present, storing this price in memory and then displaying this price. This is shown with reference to the method 398 of FIG. 6. At step 402, an input signal is placed into the system via input device 90. The controller 16 determines if an input signal has been received and compares the inputted information to the stored instruction at step 404. The stored instruction is that instruction for illuminating the second display which has previously been inputted and stored in memory. If the inputted and stored information is the same, the controller 16 instructs the second display to display the stored information at step 406. Conversely, if the stored instruction and the inputted information differ, the controller 16 saves the inputted information at step 408 in memory 18 and instructs the second display to display the newly stored information at step 406.

Thus, the systems 10 and methods of this invention may further be able to display information and change this displayed information in response to inputted information. This is particularly applicable in the use of displaying price information or other information that changes regularly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An advertising system, comprising:
a floor display;
at least one motion sensor for detecting motion;
a memory comprising instructions for illuminating the display; and
a controller, that is in electrical connection with the display, the sensor and the memory and that reads the memory and activates the display in response to a signal from the sensor.

2. The advertising system of claim 1, wherein the at least one motion sensor senses motion proximal to the display.

3. The advertising system of claim 1, further comprising a direct current power source that powers the controller.

4. The advertising system of claim 1, wherein the memory instructions further comprise instructions for instructing the controller to illuminate the display in a first pattern and a second pattern.

5. The advertising system of claim 4, wherein (i) the controller illuminates the display according to the first pattern when the sensor does not sense motion; and (ii) the controller illuminates the display according to the second pattern when the sensor senses motion and sends the signal to the controller.

6. The advertising system of claim 5, wherein (i) the system further comprises an interface switch which is coupled to the controller and which when activated sends an interface signal to the controller; and (ii) wherein the memory instructions further comprise instructions for illuminating the display in a third pattern.

7. The advertising system of claim 6, wherein the controller executes the memory instructions to illuminate the display in the third pattern when the interface switch is activated and the interface signal is sent to the controller.

8. The advertising system of claim 1, further comprising a speaker for broadcasting sounds which is in electrical communication with the controller and wherein the memory further comprises sound instructions for broadcasting a first sound.

9. The advertising system of claim 1, wherein the controller reads the memory sound instructions and activates the speaker to broadcast the first sound in response to a signal from the sensor.

10. The advertising system of claim 9, wherein the memory sound instructions further comprise instructions for broadcasting a second sound from the speaker and the controller reads the memory and activates the speaker to broadcast the second sound when the sensor does not sense motion.

11. The advertising system of claim 10, wherein (i) the system further comprises an interface switch which is coupled to the controller and which when activated sends an interface signal to the controller; and (ii) wherein the memory sound instructions further comprise instructions for broadcasting the third sound from the speaker.

12. The advertising system of claim 11, wherein the controller executes the memory instructions to broadcast the third sound when the interface switch is activated and the interface signal is sent to the controller.

13. The advertising system of claim 1, further comprising an aromatic unit in electrical communication with the controller and wherein the memory further comprises aromatic instructions for emitting the first aroma from the aromatic unit.

14. The advertising system of claim 13, wherein the controller reads the aromatic instructions and activates the aromatic unit to emit the first aroma in response to a signal from the sensor.

15. The advertising system of claim 14, wherein the memory aromatic instructions further comprise instructions for emitting a second aroma from the aromatic unit and the controller reads the memory and activates the aromatic unit to emit the second aroma when the sensor does not sense motion.

16. The advertising system of claim 15, wherein (i) the system further comprises an interface switch which is coupled to the controller and which when activated sends an interface signal to the controller; and (ii) wherein the memory aromatic instructions further comprise instructions for emitting a third aroma from the aromatic unit.

17. The advertising system of claim 16, wherein the controller executes the memory instructions to emit the third aroma when the interface switch is activated and the interface signal is sent to the controller.

18. The advertising system of claim 1, further comprising an input device which is in electrical communication with the controller and wherein instructions for illuminating the display can be changed by inputting instructions with the input device.

19. The advertising system of claim 18, wherein the input device is a wireless device.

20. An advertising system, comprising:
a display;
a motion sensor;
a memory comprising a first set of display instructions for illuminating the display in a first pattern and a second set of display instructions for illuminating the display in a second pattern; and
a controller comprising (i) an attract mode in which the controller communicates with the memory to execute the first set of display instructions and illuminate the display in the first pattern; and (ii) an audience mode in which the controller communicates with the memory to execute the second set of display instructions and illuminate the electroluminescent display in the second pattern in response to a signal from the motion sensor.

21. The advertising system of claim 20, wherein the at least one motion sensor senses motion in an area proximal to the display.

22. The advertising system of claim 20, further comprising a direct current power source that powers the controller.

23. The advertising system of claim 20, wherein the system further comprises (i) an interface switch which is coupled to the controller and which when activated sends an interface signal to the controller; and (ii) the memory further comprises a third set of instructions for illuminating the display in a third pattern.

24. The advertising system of claim 23, wherein the controller further comprises a response mode in which the controller executes the third set of instructions to illuminate the display according to the third pattern when the interface switch is activated and the interface signal is sent to the controller.

25. The advertising system of claim 24, wherein the interface switch is a touch switch.

26. The advertising system of claim 20, further comprising a speaker for broadcasting sounds which is in electrical communication with the controller and wherein the memory further comprises a first set of sound instructions for broadcasting a first sound.

27. The advertising system of claim 26, wherein the controller executes the first set of sound instructions and activates the speaker to broadcast the first sound when the controller is in the attract mode.

28. The advertising system of claim 27, wherein the memory further comprises a second set of sound instructions for broadcasting a second sound from the speaker and the controller reads the memory and activates the speaker to broadcast the second sound when the controller is in the audience mode.

29. The advertising system of claim 28, wherein (i) the system further comprises an interface switch which is coupled to the controller and which when activated sends an interface signal to the controller; and (ii) wherein the memory further comprise a third set of sound instructions for broadcasting a third sound from the speaker.

30. The advertising system of claim 29, wherein the controller executes the third set of memory instructions to broadcast the third sound from the speaker when the controller is in the response mode.

31. The advertising system of claim 26, further comprising an aromatic unit in electrical communication with the controller and wherein the memory further comprises a first set of aromatic instructions for emitting a first aroma from the aromatic unit.

32. The advertising system of claim 31, wherein the controller reads the first set of aromatic instructions and activates the aromatic unit to emit the first aroma when the controller is in the attract mode.

33. The advertising system of claim 32, wherein the memory further comprises a second set of aromatic instructions for emitting a second aroma from the aromatic unit and the controller executes the second set of aromatic instructions and activates the aromatic unit to emit the second aroma when the controller is in the audience mode.

34. The advertising system of claim 33, wherein (i) the system further comprises an interface switch which is coupled to the controller and which when activated sends an interface signal to the controller; and (ii) wherein the memory further comprises aromatic instructions for emitting a third aroma from the aromatic unit.

35. The advertising system of claim 34, wherein the controller executes the memory instructions to emit the third aroma when the interface switch is activated and the interface signal is sent to the controller.

36. The advertising system of claim 20, further comprising an input device which is in electrical communication with the controller and wherein instructions for illuminating the display can be changed by inputting instructions with the input device.

37. The advertising system of claim 36, wherein the input device is a wireless device.

38. A method of advertising, comprising:
illuminating a floor display according to a first pattern;
sensing motion; and
illuminating the floor display according to a second pattern when motion is sensed.

39. The method of claim 38, wherein sensing motion comprises sensing motion in an area proximal to the display.

40. The method of claim 38, further comprising sensing that the motion has stopped.

41. The method of claim 40, further comprising illuminating the display according to the first pattern after sensing that the motion has stopped.

42. The method of claim 3 8, further comprising receiving an interface signal from an interface switch.

43. The method of claim 42, further comprising illuminating the display according to a third pattern after receiving the interface signal.

44. The method of claim 38, further comprising broadcasting a first sound through a speaker.

45. The method of claim 44, wherein broadcasting the first sound comprises broadcasting the first sound when no motion is sensed and wherein the method further comprises broadcasting a second sound from the speaker when motion is sensed.

46. The method of claim 45, further comprising receiving an interface signal from an interface switch and broadcasting a third sound after receiver the interface signal.

47. The method of claim 38, further comprising emitting a first aroma from an aromatic unit.

48. The method of claim 47, wherein emitting the first aroma comprises emitting the first aroma when no motion is sensed and wherein the method further comprises emitting a second aroma from the aromatic unit when motion is sensed.

49. The method of claim 48, further comprising receiving an interface signal from an interface switch and broadcasting a third aroma after receiver the interface signal.

50. The method of claim 49, further comprising inputting instructions for illuminating the display to a system that controls the illumination of the display.

51. The method of claim 50, wherein inputting instructions further comprises inputting the instructions with a wireless device.

52. A method of advertising, comprising:
illuminating a floor display according to a first pattern;
sensing motion;
illuminating the display according to a second pattern when motion is sensed; and
receiving an interface signal; and
illuminating the display according to a third pattern after receiving the interface signal.

53. The method of claim 52, wherein sensing motion comprises sensing motion in an area proximal to the display.

54. The method of claim 52, further comprising sensing that the motion has stopped.

55. The method of claim 54, further comprising illuminating the display according to the first pattern after sensing that the motion has stopped.

56. The method of claim 52, further comprising broadcasting a first sound through a speaker.

57. The method of claim 56, wherein broadcasting the first sound comprises broadcasting the first sound when no motion is sensed and wherein the method further comprises broadcasting a second sound from the speaker when motion is sensed.

58. The method of claim 57, further comprising broadcasting a third sound after receiver the interface signal.

59. The method of claim 52, further comprising emitting a first aroma through an aromatic unit.

60. The method of claim 59, wherein emitting the first aroma comprises emitting the first aroma when no motion is sensed and wherein the method further comprises emitting a second aroma from the aromatic unit when motion is sensed.

61. The method of claim 60, further comprising emitting a third aroma after receiver the interface signal.

62. The method of claim 52, further comprising inputting instructions for illuminating the display to a system that controls the illumination of the display.

63. The method of claim 62, wherein inputting instructions further comprises inputting the instructions with a wireless device.

64. An system for conveying information, comprising:
a floor display;
a speaker;
at least one motion sensor;
a memory comprising instructions for illuminating the electroluminescent display and for creating a sound to be broadcast by the speaker; and
a controller, that is in electrical connection with the display, the speaker, the sensor and the memory, the controller executing the memory instructions in response to a motion sensed signal from the sensor to illuminate a first pattern on the electroluminescent display and to broadcast a first sound through the speaker in response to the signal.

65. The system of claim 67, further comprising an aromatic unit and wherein the memory further comprises instructions for emitting an aroma from the aromatic unit and the controller activates the aromatic unit to emit an aroma from the aromatic unit.

66. The system of claim 68, further comprising an interface unit which is in electrical communication with the controller and wherein the controller executes the memory instructions in response to a signal from the interface unit to illuminate a second pattern on the electroluminescent display and to broadcast a first sound through the speaker in response to the signal.

67. The system of claim 69, further comprising an input device which is electrical communication with the controller, the input device being for inputting new memory instructions which can be stored in the memory.

68. An system for advertising, comprising:
an output device;
at least one motion sensor;
a memory comprising instructions for generating a first output from the output device;
a controller, that is in electrical connection with the output device, the speaker, the sensor and the memory, the controller executing the memory instructions in response to a motion sensed signal from the sensor to generate the output in the display; and
an input device for changing the memory instructions to generate a second output from the output device.

69. The system of claim 68, wherein the output device comprises a floor decal.

70. The system of claim 68, wherein the output device comprises a speaker.

71. The system of claim 68, wherein the output device comprises an aroma generator.

72. The system of claim 68, wherein the input device comprises a touchpad.

73. The system of claim 68, wherein the input device comprises a remote device.

74. The system of claim 68, wherein the remote device is a wireless device.
